(19) United States
(12) Patent Application Publication
(10) Pub. No.: US 2007/0255663 A1
(43) Pub. Date: Nov. 1, 2007

(54) System and Method for direct negotiation between buyers and sellers for products and services, and between buyers and Lending and Travel services

(76) Inventors: Randy Jordan, Hunterville, NC (US); Richard Samko, Hunterville, NC (US)

Correspondence Address: FURR LAW FIRM, 2622 DEBOLT ROAD, UTICA, OH, 43080, US

(21) Appl. No.: 11/306,356

(22) Filed: Dec. 23, 2005

Related U.S. Application Data
(60) Provisional application No. 60/593,230, filed on Dec. 23, 2004.

(51) Int. Cl. H04L 9/00

(52) U.S. Cl. 705/80

(57) ABSTRACT

This invention is a system with a website and software download to be used for negotiation between online buyers and sellers, lenders and travel agents. Buyers and sellers are put in direct communication to make offers and counteroffers on products and services listed online. The current invention will also provide an option for the buyer to ask for, or make a monthly payment offer lending products that may or may not be related to the their pending purchase. Lenders will also be able to make offers or offer their financing services to every buyer that is negotiating a Product or service such as lending products including loans for the purchase of ideas, such as cars or property that a buyer is buying from a seller.

### RELATED APPLICATIONS

The application is an Non-provisional application of Provisional Application 60/593,230 filed Dec. 23, 2004.

### BACKGROUND OF INVENTION

1. Field of the Invention

The invention relates to a website and downloadable software for direct negotiation between buyers and sellers for products and services.

2. Description of Prior Art

The World Wide Web is currently a subject of intense and rapidly growing interest. The World Wide Web is composed of interconnected data sources that are accessible to computer users through data-communication networks such as the Internet. The data available on the World Wide Web has been assembled by private individuals, commercial companies, government agencies, and special interest organizations. Much of this assembled information is organized into Web pages. A Web site is a collection of Web pages (and possibly other data which, together with Web pages, are generically referred to as Web components) offered by a sponsoring entity, herein referred to as the site owner.

Large Web sites are typically organized hierarchically. For example, corporate Web sites often consist of smaller Web sites, each providing information about a business unit of the parent company.

The Web site itself resides on one or more server hosts. Web components stored on the server host are offered to users of the World Wide Web through a software program known as a Web server. A network user uploads or downloads data from a Web site through a browser, a software program running on the client host. The browser establishes contact with the Web server and issues a request for data stored on the server host. This results in data from the server host being downloaded into the browser. This data is typically a HyperText document specifying information required by the browser to display the Web page (i.e., formatting information specifying the structure of the page, or URLs of images that are to be placed on the page), embedded client software programs which run inside the browser (e.g., Java bytecode), and other content to be downloaded to the client computer or displayable through client software programs that add to the browser's functionality (sometimes referred to as “browser plug-ins”).

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

With the rapid growth of computer networking and requests for information from one computer to the next e.g. the Internet, it has become common practice for a provider of information (a “Server”) to provide each specific requester of information (a “Client”), with an electronic “token” (commonly referred to as a “Cookie”) for the purpose of “recognizing” the client and/or providing some pre-determined and pre-programmed level of customization at the discretion of the information provider.

Online businesses such as Priceline.com and eBay.com have been created for the purpose of connecting the buyers and sellers of products and services. Priceline.com markets various industries to consumers at prices below market rate. Consumers can make an offer on any of the services presented by the participants of Priceline.com. Priceline.com will then initiate an automated search for a participating business that will accept the consumer's offer. In dealing with Priceline.com, consumers can choose their price, but then they must only choose one of the options given to them by Priceline.com. In other words, consumers do not know upfront when naming their price which companies will be selected by Priceline.com to do business with the consumers. The consumer therefore has little say in the negotiation of the brand of product, but not necessary the type of product. Priceline is largely an automated system that deals with sellers in the travel industry.

A significant problem with both, Priceline and Ebay, is that the user must go to their site. They are not site independent.

On the other hand, eBay.com provides an online auction where sellers have little say in the negotiation. Buyers have more power on eBay.com because they make bids at their will on the products and services being offered. Also, the seller is required to give eBay.com a share of the money made when an item sells.

There is a need for a system, especially an internet based system that will allow more flexibility for the consumers to be able to choose their price and their options as well as allowing the sellers to have a greater say in the negotiation. There exists a need to provide the benefit to consumers where they are able to make an offer on any product regardless whether it is for sale, discounted, etc. Where the consumer will not only have flexibility when it pertains to price and their options, but also product and services. Where the Sellers are able to negotiate with buyers directly (or live) or via an automated reply system. A system that can add a negotiation platform that integrates into the sellers website. This will enable Sellers to capture more of their traffic, and sell more products and services.

There is still room for improvement in the art.

### SUMMARY OF INVENTION

This invention is a website and software download to be used for negotiation between online buyers and sellers, whose privacy is protected by the option of anonymity.

The system can be used with offline products with using the internet. For example, a buyer looks at a car (say a business that doesn't have a website, but a seller that has an e-mail address) gets the e-mail address of the seller, and sends them an offer. Buyers and sellers are put in direct communication to make offers and counteroffers on products and services listed online as well as offline.

It is the objective of the current invention to provide a system that will allow more flexibility for the consumers to be able to choose their products, price and their options as well as allowing sellers a negotiation platform designed to help them win over more customers.

The current invention will also provide an option for the buyer to ask for, or make a monthly payment offer for lending products that may or may not be related to the their pending purchase. Lenders will also be able to make offers or offer their financing services to every buyer that is negotiating a Product or service such as lending products including loans for the purchase of ideas, such as cars or property that a buyer is buying from a seller.

The system is unique as it allows live offers and negotiations to be between one or more live people such as buyer and seller, travel agent and/or lender.

The current invention utilizes the Internet as well as faxes and wireless systems. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The system is more efficient, effective, accurate and functional than the current art.

Definitions:

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its

raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet;

FIG. 2a shows the system main web page for the Buyer;

FIG. 2b shows the system main web page for the Seller;

FIG. 3 shows the system optional tool bar;

FIG. 4 shows the communications between the buyer and seller;

FIG. 5 shows the offer screen;

FIG. 6 shows the E-mail confirmation;

FIG. 7 displays a live transaction summary page;

FIG. 8 shows a seller summary list;

FIG. 9 shows a manager list;

FIG. 10 shows some sample link language;

FIG. 11 shows an example of a link on a seller's website;

FIG. 12 displays a screen where a buyer can make an offer to the Seller and Lender Network;

FIG. 13 displays a screen where the financial terms can be entered;

FIG. 14 displays financial offer for a Home purchase;

FIG. 15 displays the lender account screen;

FIG. 16 displays the travel offer screen; and

FIG. 17 displays the feature screen.

### DETAILED DESCRIPTION

The following description is demonstrative in nature and is not intended to limit the scope of the invention or its application of uses.

There are a number of significant design features and improvements incorporated within the invention.

The current invention is a system with a website and software download to be used for negotiation between online buyers and sellers, whose privacy is protected by the option of anonymity. Buyers and sellers are put in direct communication to make offers and counteroffers on products and services listed online as well as offline.

The computer application that includes the user interface for this invention will henceforth be referred to as “the System 1.” The system is network based and works on an Internet, Intranet and/or Wireless network basis as well as a stand alone and fax based system.

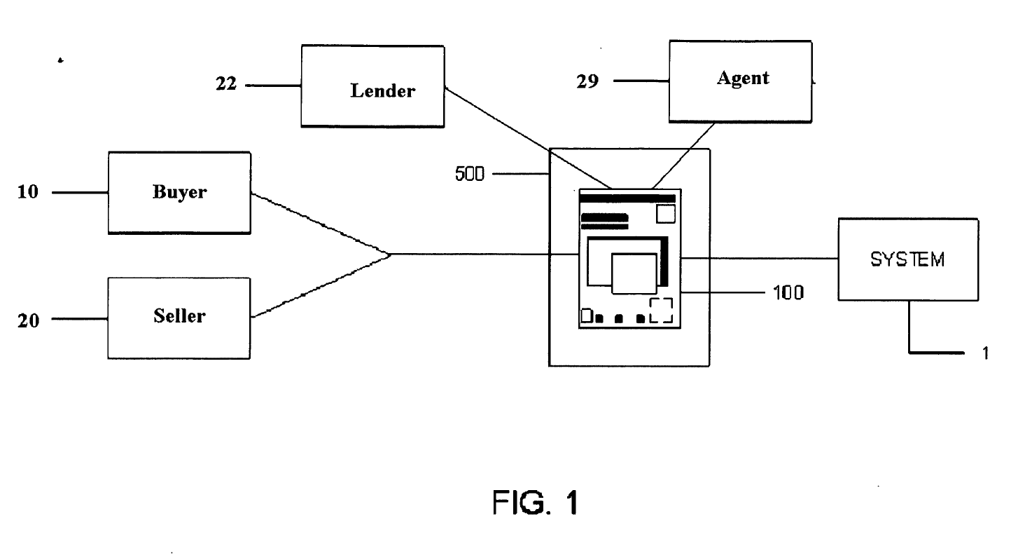

FIG. 1 illustrates a functional diagram of a computer network for World Wide Web 500 access to the System 1 from a plurality of Users 10 who access the system Web Site 100 or the Users/Buyers 10 can connect directly to the System 1. The buyer 10 can also access the Seller 20 directly. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT7T or Verizon.

The Buyers 10 and Sellers 20 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Buyers 10 and Sellers 20, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Buyers 10 and/or Sellers 20 connect to the System Web Site 100. In the preferred embodiment the system has numerous web pages. The information in the web pages are in HTML format via the HyperText Transport Protocol (http) and on Server System 310. The User System 110 includes software to allow viewing of web pages, commonly referred to as a Web Browser, such as Communicator available from Netscape Communications Corp. or Internet Explorer available from Microsoft Corp. The user system is capable of accessing web pages located on Server System 310.

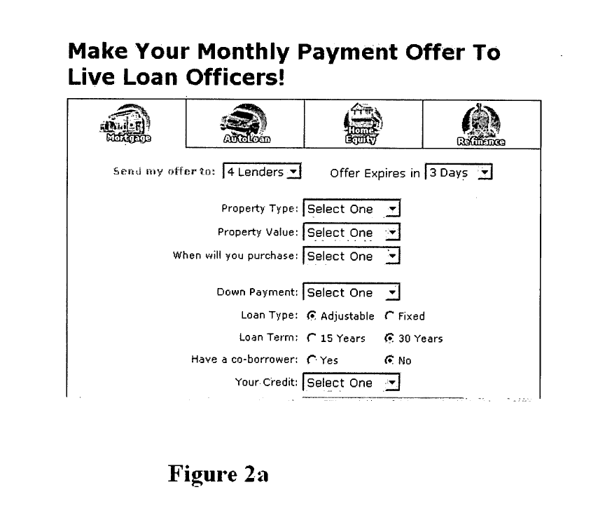

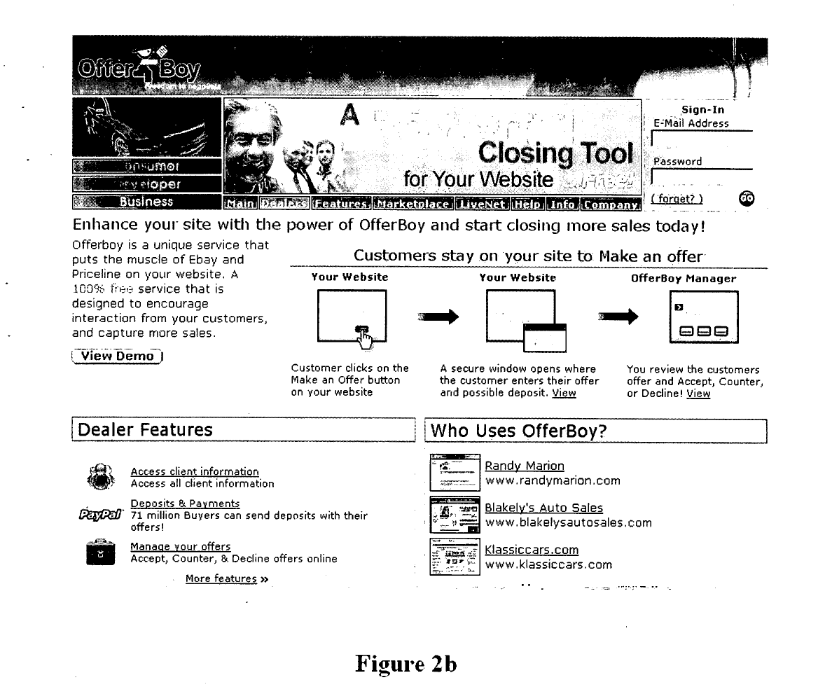

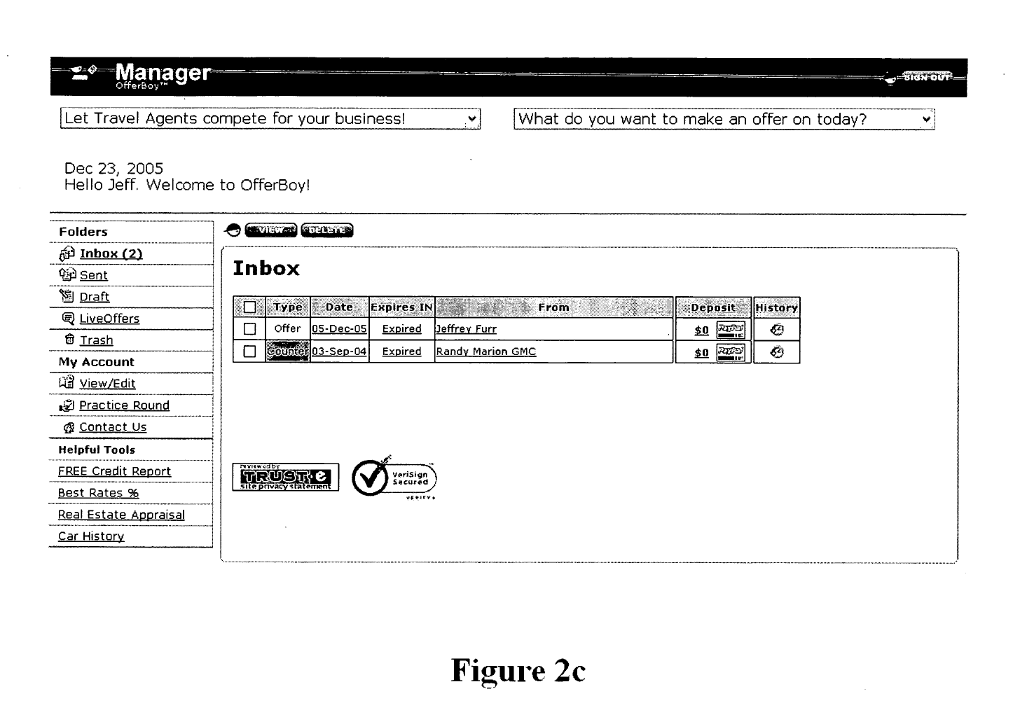

In one preferred embodiment of the invention, the Users 10 connect to the Web site 100. The system 1 would have a standard home web page 200 for users 10 shown in FIG. 2a. This home web page 200 would have information about the system 1 as well as a standard login as shown in FIG. 2a. The web page 200 would have an area where the buyer 10 would enter Sellers offering price, product description, Seller's price, when the offer expires, the seller's name, the seller's E-mail address and comments. The web page 200, in the preferred embodiment, would also have an area to make offers and request up to 4 lenders and travel agents to respond. The main web page 200 in the preferred embodiment would also have a sample of how it works. This would include the main steps as well as a network of sellers which consists of images and text that hyperlink to the seller's web page.

The system is unique as it allows live offers and negotiations to be between one or more live people such as buyer and seller, travel agent and/or lender.

The system 1 would have a standard home web page 200 for seller 20 shown in FIG. 2b. This home web page 200 would have information about the system 1 as well as a standard login as shown in FIG. 2b. This web page 200 will inform the seller 20 on how to use the system 1 and set the system 1 up on their website 300. It will also provide links to the system's seller management area, payment and client areas.

The system 1 or website 100 also includes a manager function, as shown in FIG. 2c, where buyers 10 and sellers 20 not only will view offers made, and received, they can accept, counter, and decline from the manager. There is also a forum, and the ability to practice for free sending and responding to offers.

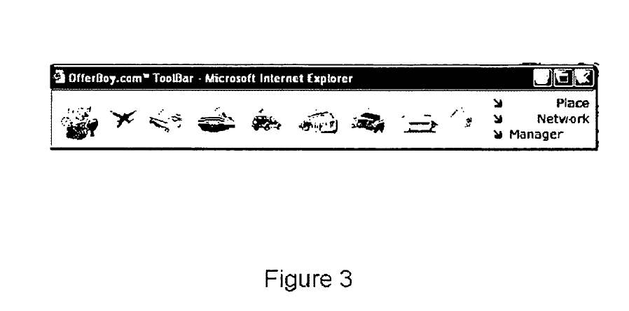

The system 1 may also has a standard toolbar as shown in FIG. 3 which consists of images and text that hyperlink to the seller's web page or to the system. The Tool bar is an active window that houses a selection of industry specific templates. As a buyer would cruise through internet sites, the buyer could select and open a template to make the internet seller an offer. The user 10 will have use of the tool bar to select the appropriate templates (if using the website), and if the user has downloaded the software, then there will be a similar content as on the tool bar for the user to select templates.

Sellers

The system 1 will provide the sellers 20 with unique code that creates a small icon link (“Make an Offer” icon will be linked to system 1) to be placed on their website 300. The Seller 20 or business has the option to place the button on a single or multiple products on their website. The system 1 has a link wizard that automatically creates unique code in PHP, Java, HTML, Cold Fusion, ASP to be chosen by the seller 20 based upon the language their site is written in. The system 1 also makes available downloadable software for sellers that choose to run or have system ion their own server. In the preferred embodiment, the software and unique link code can be obtained by going to system's website 100, where the software and link code will be available in a downloadable format, or instructions on how to implement the link code to their website. This code In the preferred embodiment, included in the download will be explanations on how the software will interact with their website, with a number of choices; of “Make an Offer” icons (selection of small and medium sized icons), Terms and Conditions of usage, the ability to choose from different types of formats that would best apply to their product or service, and instructions on how to install/incorporate the icons within their website, also Seller can manipulate text and industry specific templates to say anything they want such as your best price, deal time, etc. The software will perform several offer management functions, allowing the seller to organize, save, and reply to multiple offers.

The software is designed so that will also be compatible with other software used by the seller's website 300. For example, the seller 20 may have “shopping cart” software, where the seller 20 uses the system 1 to reach a negotiated and final price with user 10, then user 10 would “check out” using the “shopping cart” software.

The Sellers 20 who integrate the link to the system 1 into their web site have the option of choosing a static hyperlink, or dynamic hyperlink. A dynamic link will open a template on the sellers web site 300 with detailed product information pulled from the sellers own data base, and pre-populated into the template fields. A static link will present a template that the user must enter information gathered from the seller's web site 300 into the template fields.

The seller 20 will access their offer data via a web based management system 1, or they may download the offer data onto their own servers by downloading system 1 software. If the Seller has purchased Solutions, then their data is run through and stored on their own server.

Once the buyer 10 clicks an icon or some other type of hypertext function, a pop up window appears within the seller's website 300. The buyers 10 will see a friendly window showing them that they can make an offer, negotiate, and ultimately offer their own price or monthly payment by using the system 1. The window itself will be a simple platform, which will have the following main components: registration, payment, and in some industry specific templates, the ability to Make an offer to or request financing information or loan information.

The window or template can be tied to the seller's data base which will pre-populate specific product information into the template; and/or it can be a generic window or template that opens prompting the user/buyer to enter in the product info and name their price and terms.

As the buyer 10 goes through the process of making an offer 60, there are formatted categories to be used as guides: Description of Product/Service, Comments/Requests/Conditions, Their Price, Your Price, and Expiration Date. In some industries such as Travel or Lending, the templates may guide the user 10 to input more necessary information for the Travel agent or lending bank to make negotiation decisions, such as travel dates, number or participants, or for lending, their credit status, desired loan type, etc. . . . If the template is not pulling and pre-populating fields in the template, then the buyer 10 will select products and services through a “shopping cart” feature, or a seller's 20 description of their product/service. While making an offer, the buyer 10 will be prompted to grab the seller's information using the “drag” function, or entering the offer information manually. The drag feature allows the buyer 10 to highlight and drag the appropriate information and drop it into the system's platform. The buyer 10 and seller 20 will have the ability to negotiate on price, options, terms, etc. After the buyer 10 is finished selecting the items, they will input what they would like to offer (price and terms) for the selected products or services and “Send Offer” At this point, the software connects with the system 1 and initiates the automated e-mail 30, fax 40 and/or wireless responses.

If the seller 20 has the software load on their site 300, then the offer would go directly to the seller 20.

Buyers

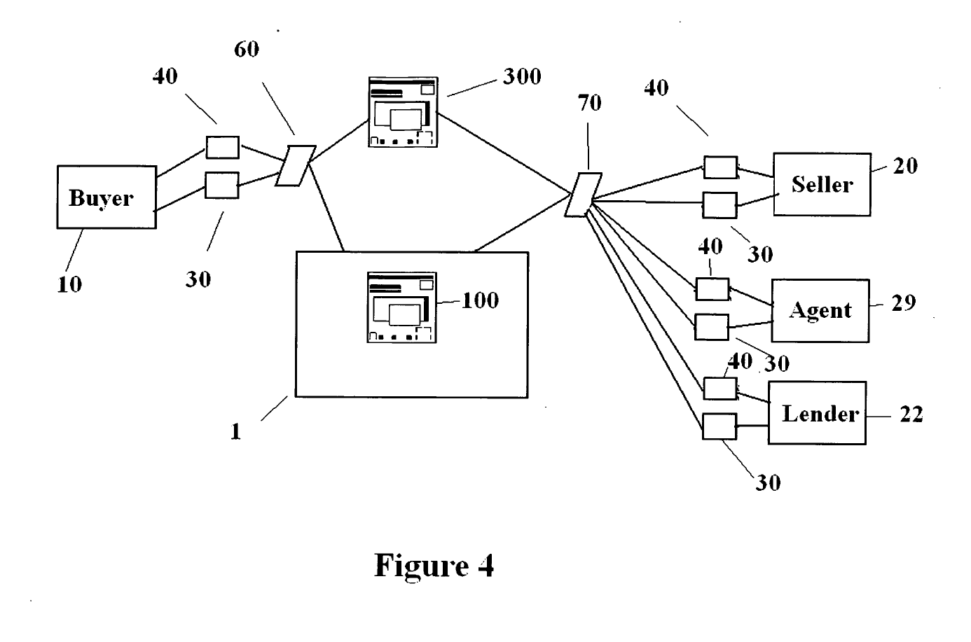

The system 1 will also be used by the buyers 10. They will have the option of accessing the system 1 via the internet or downloading the system 1 and its software onto their computers by going to the system's website 100 in the preferred embodiment, although other means of transferring the software such as on a CD disk will work as well. The system 1 will give the buyer 10 templates to use with any on-line sales transaction, and with any seller 20 they choose. The platform window will have the same capabilities and functions as described above in the Seller's description. In some cases the seller 20 will not know of system 1, so there will be an additional feature added to the consumer version. The buyer 10 will be asked if they would like to notify the seller 20 of their offer via e-mail 30, fax 40, or wireless—SMS, and other wireless technology as shown in FIG. 4.

Once the buyer 10 has located a product or service on the internet that they would like to make an offer on, they will open the Offer part of the system 1.

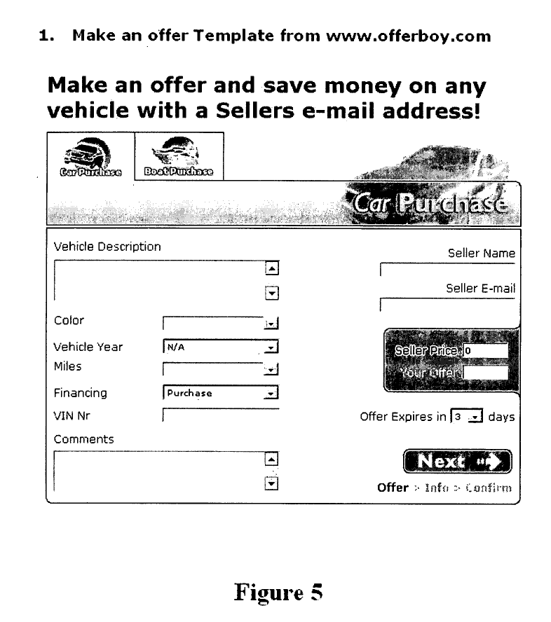

As shown in FIG. 5, a template window will open and the buyer 10 will enter the relevant information such as the item or services, the seller 20, the seller's E-mail address, the offer and the time offer is open for. To make an offer, the buyer 10 simply fills in the fields of the template. For example for a car, the buyer would describe the car that they are interested in buying: it could be described by VIN#, year, type, and color, etc. . . . the seller's price (their asking price), the offered price, the seller's name (Hank's Autos), and their email address (either the salesperson or dealership). Use the mouse to press “GO” to send an offer.

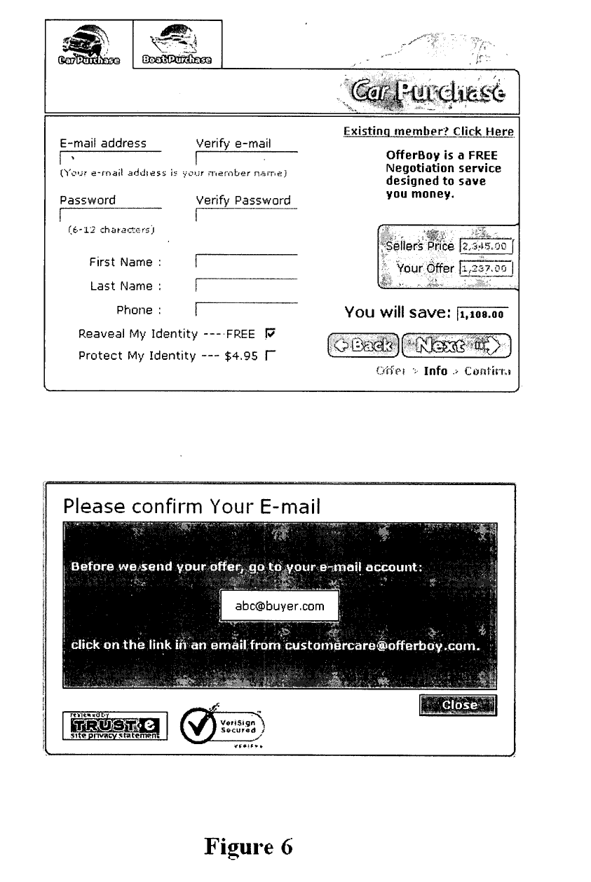

In the preferred embodiment, after sending the offer, a confirmation and sign-in screen will appear as shown in FIG. 6. If the buyer 10 is a first time user, the system will set up their account.

Once the original offer has been sent, the seller 20 will be notified via e-mail 30, and/or notified via fax 40, or wireless—SMS, and other wireless technology that they have a potential sale waiting for them. If Seller is notified via e-mail 30, then the seller 20 can click on a link which will hyper link them directly to the system's 1 manager to review, and ultimately accept, counter or decline the offer. The buyer 10 will receive e-mail 50 notification confirming the offer 60 has been sent to the seller 20. The seller's e-mail 30, Wireless notification 35 and/or fax 40 will contain an “Offer number” and/or user auto generated username and password with instructions to go to the system's website 100 to review the offer 60. The seller 20 is can press on a hyper link in the E-mail 30 or they can go to website 100 with a username (their email address) and password that has been automatically created for them. This will be the case on e-mail 30, fax 40, and wireless 35. Upon visiting the website 100, the seller 20 can download the software onto their server for future convenience, and/or the seller 20 may use the “Offer number” or username/password to review the offer 60. The seller 20 can accept, reject, or counter back to the buyer. If the seller makes a counteroffer 70, the buyer 10 will be notified via e-mail to review the counteroffer 70 on the system 1. The buyer 10 can review the offer on the system 1 and/or download the offer data to their own computer for further review if they have downloaded the software. The seller 20 and buyer 10 can choose to use the system's negotiation platform as many times as needed.

In the preferred embodiment, there is a fee charged to the buyer 10 if they choose anonymity while negotiating with the Seller 20, via a charge card or other forms of acceptable on-line payment options (PayPal or WorldPay). The seller 20 will use this service for free, and make as many counteroffers as necessary to complete the sale. The buyer and seller get together with their agreed upon offers or contracts and consummate the deal.

Website

The website 100 will have many of the components described above and will appear similar to the off-line system 1 environment. The site 100 will ask for the users 10 to enter their names and passwords to access their accounts. Once on their account, they will be able to review offers, counter, send new offers, download offer data, refer a friend, etc. The site will also create a rating system for the buyers and sellers based on a history of past offer information. The system 1 will use factors from successful offer/acceptance ratios, frequency of usage, and percentage of original asking price vs. offer/accepted price. In the preferred embodiment, the system 1 will award titles to members, such as Platinum, Gold, Silver, and Bronze members, to be promoted to sellers on future offers. The site will maintain a chat room feature so that members can discuss deals as well as various techniques used to negotiate with sellers.

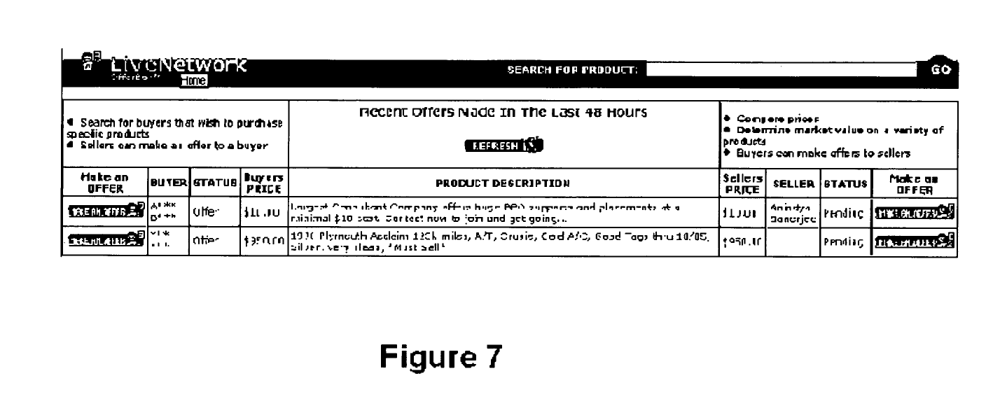

The website 100 will have a live update of all of the transactions such as the offers and counteroffers that are currently being processed on the system 1 as shown in FIG. 7. The information will include buyer 10 who can be anonymous if requested, the buyer's status, the buyer's proposed price, the product description, the seller 20, the seller's status, and the seller's price.

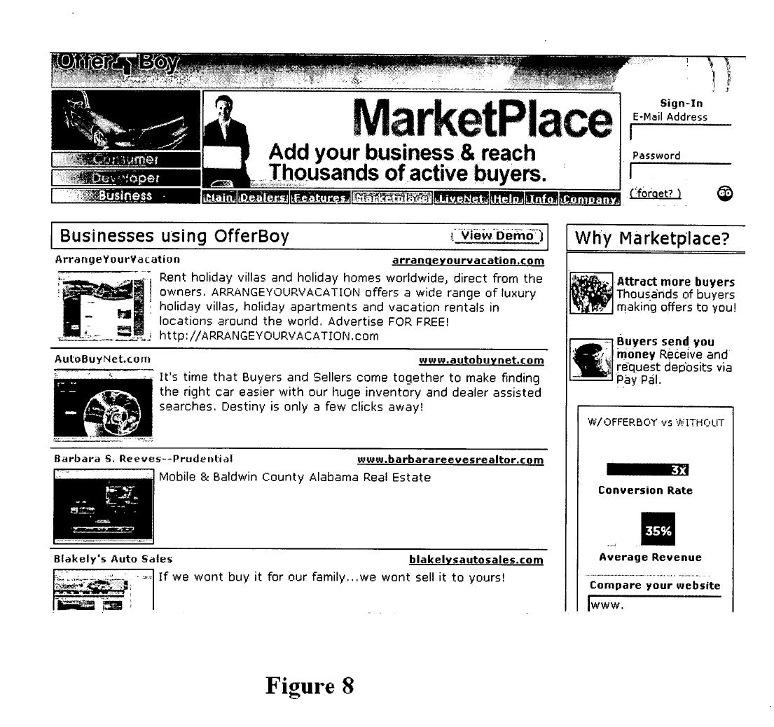

The website 100 of the system 1 will have a webpage that has a list of all of the companies and seller 20 that use the system 1 to allow a User 10 to make an offer on their goods or services. An example of this list is displayed in FIG. 8. The webpage will have the name of the seller 20 with a web link to the seller's site and a description of the services provided by the seller 20.

In the preferred embodiment, the system 1 will have a Practice site/Demo site: This will be a static display of screens and/or flash demos that are designed to educate buyers 10 on how to make an offer. At the end of the display, the screen goes active allowing the user to practice making an offer. The system 1 will also have an automated practice round allowing the user to practice making an offer.

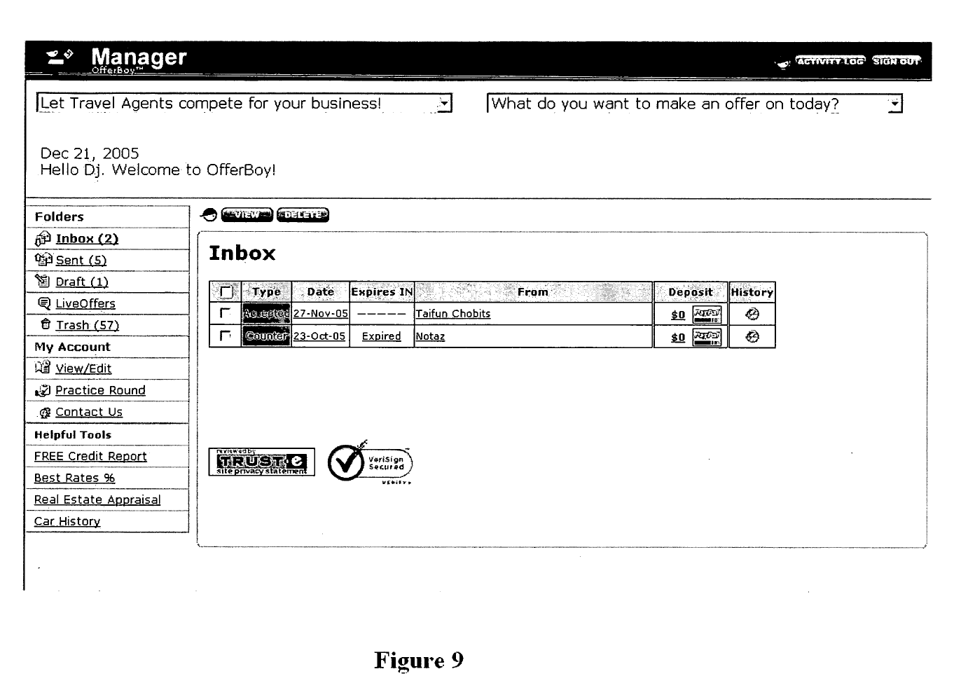

The system 1 will have a manager page through which a buyer is able to manage their offers. This page will show the User 10 the items or services that she has made an offer on and offers received, and the time and date that the offer expires. The system 1 has a draft folder function that will notify you via e-mail when you have started an offer an have not completed the offer. This is shown in FIG. 9. The system 1 can incorporate automatic payment systems, like Paypal, in the manager for buyers who wish to make a payment or deposit with their offers, or Sellers who wish to request from the buyer a payment or deposit with their offers.

Weblinks

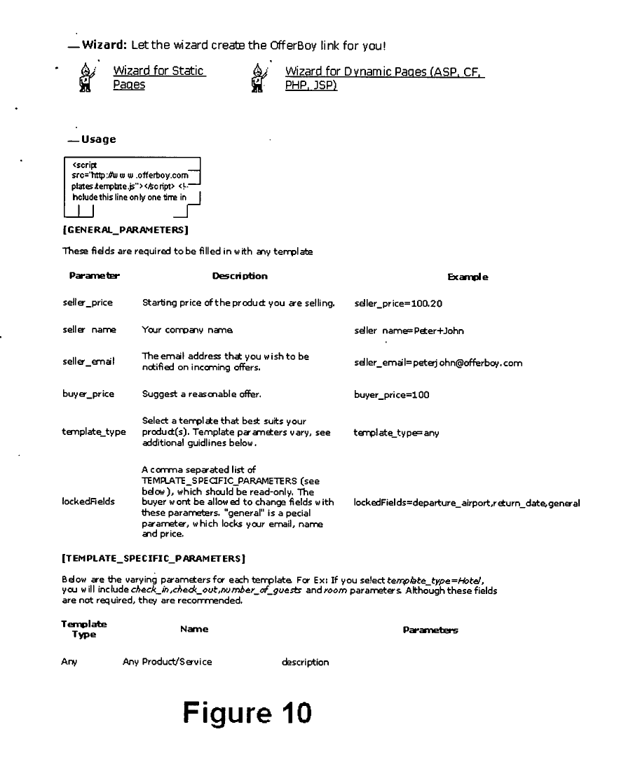

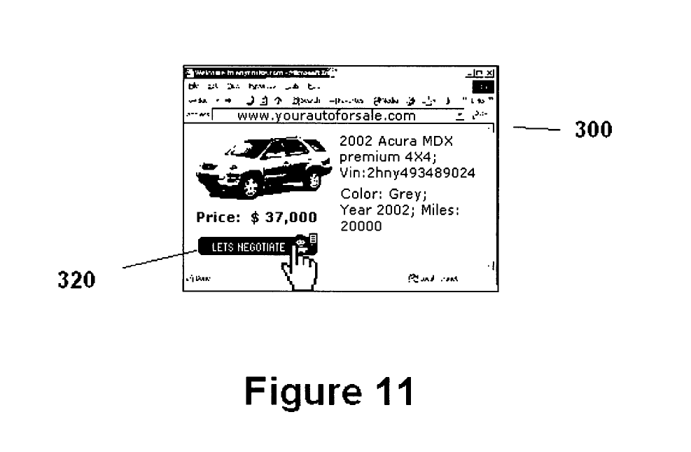

The system 1 will have a set up a link option. This option in the preferred embodiment is given on the website 100. This option will allow a seller 20 to add a web link to the system 1 allowing a buyer 10 to be able to make an offer on the seller's goods or services. The system 1 will have an automatic link language generate which will create the linkage language for the seller automatically. The website 100 will also have sample language as shown in FIG. 10 that a seller 20 can cut and paste the language that suits their needs and business. The system 1 will offer help and assistance in setting up the link on the user's 10 system. FIG. 11 shows an example of a link on a seller's website 300. When a user 10 clicks on the link icon 320 the user 20 will be transferred to the system 1.

Lending

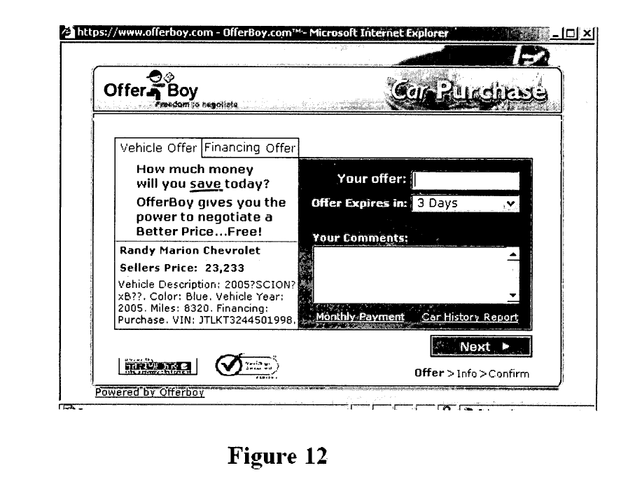

The system will have lending requests and Offers. Lending screens on a seller's site as shown in FIG. 12: When a Seller 20 sets up the system 1 on their website 100, they can choose to have a lending & Make an offer screen together. The buyer 10 can make an offer on a home or vehicle, or request financing on that home or vehicle, or both.

As financing is requested buyer, that information is passed via the system's platform to the seller and the lenders in our Lending Network, and they will take the information they have and make or respond to the buyers offer.

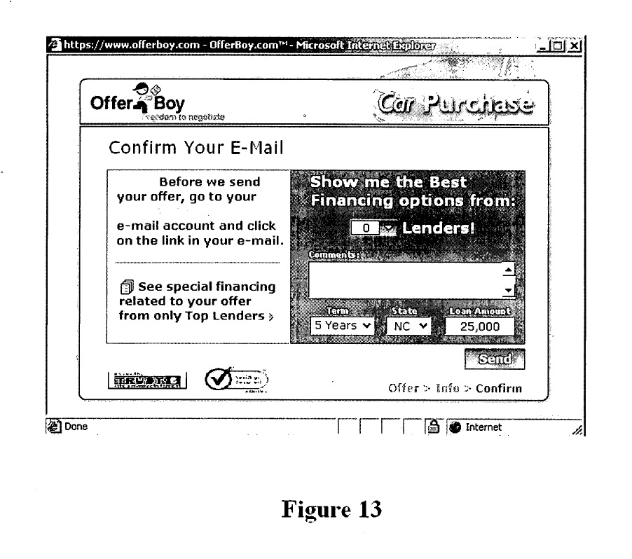

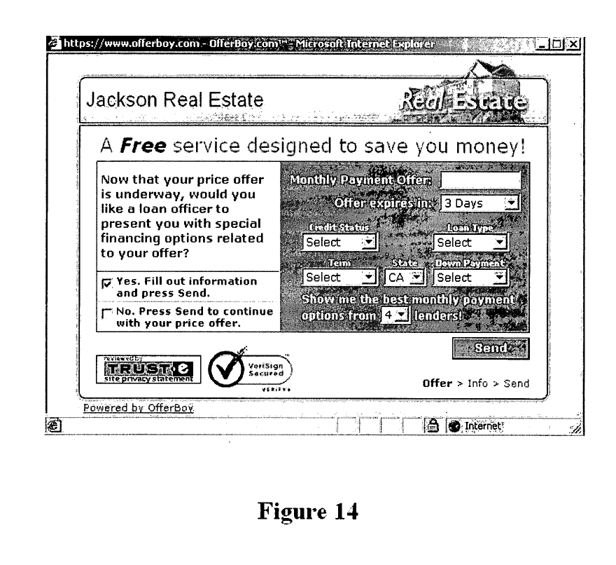

The make an offer screen's on the seller's site 100 as shown in FIG. 13: The Seller 20 will also have the option of presenting just the Make an Offer Screen to the buyer 10. As the buyer 10 goes through the process of making an offer, in the preferred embodiment, the buyer 10 will be prompted at the end to “Make a monthly payment offer and/or Receive up to 4 3 financing options related to your pending purchase offer”. FIG. 14 displays a financial offer for a home purchase.

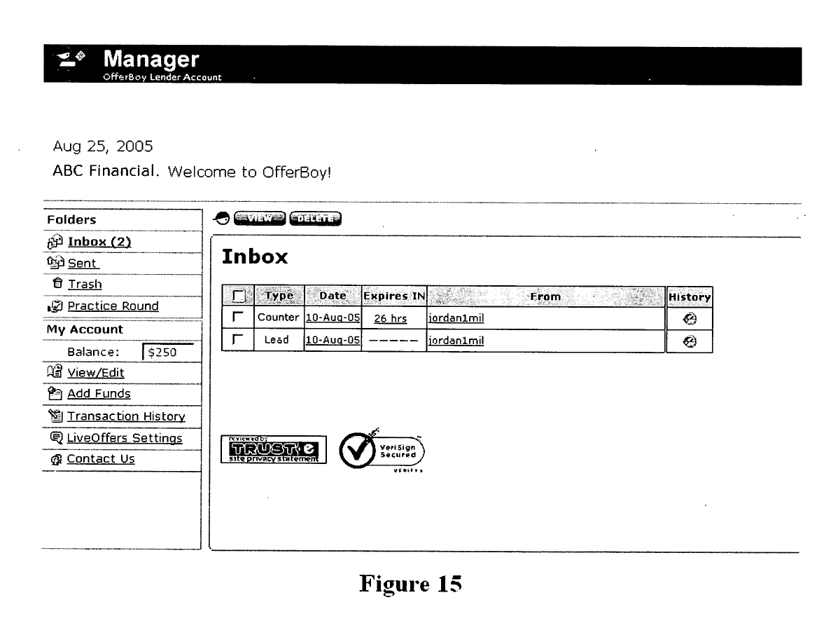

As financing is requested by buyer 10, that information is passed by the system platform to the Seller 20 and the lenders 22 in the Network. The lenders 22 will take the information they have and make the buyer 10 an offer, or counter offer. FIG. 13 displays a screen where such financial information will be entered. FIG. 14 displays a financial offer for a home purchase. The offers and negotiations from the lenders 22 are shown in the lender account screen as shown in FIG. 15.

The System 1, and sellers 100, as well as being a place where the buyers 10 are in the process of negotiating a purchasing an item such as a home or car. The system 1 will prompt the buyer to request free financing options. That lead information is sold to lenders who join the system's lender network. The can choose to respond to the buyers mortgage or auto loan request via the system 1, or respond by calling or emailing the buyers.

The Lenders 29 can manage their lending offer from their Lending network manager as shown in FIG. 15. In the preferred embodiment, the lenders 22 will deposit funds into their manager to pay for the leads/financing requests. Responding to buyers requests for financing can be automated or manual. Live offer settings allows the lenders to solicit buyers by sending generic offers by pre-setting loan conditions. These live offers would go to buyers that have made a price offer on a auto or real estate, but have not requested financing information. These solicitation offers will go into the buyers “Live Offer” folder in their manager (similar to a Spam folder). Settings can be changed in “Live offer Settings”.

The system 1 will allow lenders 22 to pull transaction reports on their transactions.

Travel

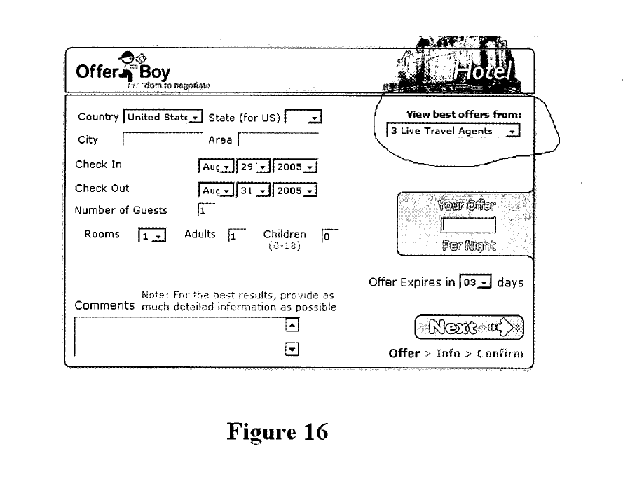

As shown in FIG. 16, the system 1 will allow a buyer 10 to make an offer to live Travel Agents. The buyers 10 will be prompted via their manager accounts, email marketing campaigns, or simply from the system's main webpage, to make an offer on travel to up a plurality of travel agents 29. The travel agents 29 can choose to join the system's travel network, where the system will take buyer's offers for travel and filter them to live agents 29 to respond to their offer. Travel agencies or agents will sign up for the network denoting certain areas of expertise or designations. The offers will be filtered based on these travel agent inputs, and sent to the agent who can best meet the needs of the buyer 10. The travel agents 29 will manage their account from their account manager. The travel agents 29 will deposit funds into their manager to pay for the leads/responses to buyers offer. They can pull transaction reports from the system 1. The screens for the travel offers are similar to the other make offer screens in the system.

Features

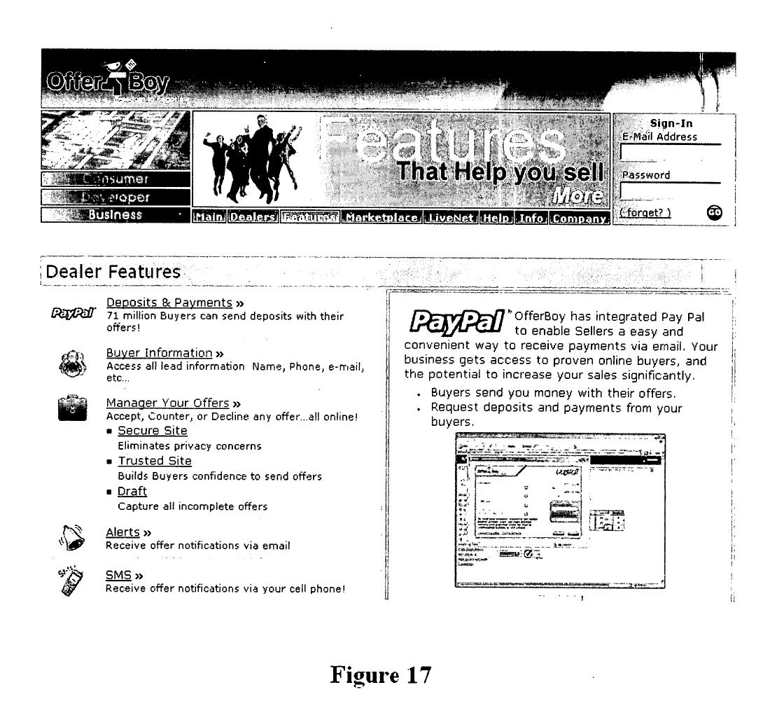

As shown in FIG. 17, the system 1 can have a set of unique of offer templates that have the option of adding certain features for the buyer to use. For ex: Car purchase templates can have: Car fax, and e-loan or Pay Pal. Real Estate Templates can have a Home appraiser function.

### CONCLUSION

The system 1 is set to run a on a computing device. A computing device on which the present invention can run would be comprised of a CPU, Hard Disk Drive, Keyboard, Monitor, CPU Main Memory and a portion of main memory where the system resides and executes. A printer can also be included. Any general purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. What is claimed is:
A negotiation system comprising:
A website where a plurality of buyers can make an offer to a plurality of sellers.

2. A negotiation system as defined in claim 1 where said sellers use a system website to sell their product.

3. A negotiation system as defined in claim 1 where said sellers use their own website to sell their product.

4. A negotiation system as defined in claim 1 where said sellers use a third party's website to sell their products.

5. A negotiation system as defined in claim 1 further comprising said system having the ability to create a web link to the system on a webpage.

6. A negotiation system as defined in claim 1 further comprising having lenders make financing offers to said buyer.

7. A negotiation system as defined in claim 6 where said financing offers are based on payments.

8. A negotiation system as defined in claim 6 where said financing offers are based on loan amount.

9. A negotiation system as defined in claim 6 where said financing offers are for a product that said buyer bought from a seller.

10. A negotiation system as defined in claim 1 where said sellers are travel agents.

11. A negotiation system as defined in claim 10 where said travel agents are available real time.

12. A negotiation system as defined in claim 1 where as system is connected to an automatic payment system.

13. A negotiation system as defined in claim 1 where said seller can create a dynamic link on their website.

14. A negotiation system as defined in claim 1 where said system offers live interaction between Buyer and Seller.

15. A negotiation system as defined in claim 1 where said buyer can be anonymous.

16. A negotiation system as defined in claim 1 further comprising having buyers make financing offers to a plurality of lenders.

17. A negotiation system as defined in claim 16 where said financing offers are based on payments.

18. A negotiation system as defined in claim 16 where said financing offers are based on loan amount.

19. A negotiation system as defined in claim 16 where said financing offers are for a product that said buyer bought from a seller.

20. A negotiation system comprising:
A website where a plurality of buyers can make an offer to a plurality of sellers with said buyers and sellers accessing the System through a Web Site through a web page where the buyer would enter one or more of the following select; Sellers offering price, product description, Seller's price, when the offer expires, the seller's name, the seller's E-mail address or comments, the system has an account manager function where users will be able to view offers made, and received, where they can accept, counter, and decline offers where said buyer and seller will negotiate the terms of the transaction, where said system offers live interaction between Buyer and Seller, where said sellers can be travel agents and lenders and where a plurality of lenders can make financing offers to said buyer and said lenders can make a financing offer to a plurality of said lenders.
